(19) United States
(12) Patent Application Publication
(10) Pub. No.: US 2022/0147157 A1
(43) Pub. Date: May 12, 2022

(54) KEY STRIKE CAPTURE

(71) Applicant: Hewlett-Packard Development Company, L.P., Spring, TX (US)

(72) Inventors: Chin-Yu Wang, Taipei City (TW); Christoph Graham, Spring, TX (US); Charles Shaver, Spring, TX (US); Irwan Halim, Spring, TX (US)

(73) Assignee: Hewlett-Packard Development Company, L.P., Spring, TX (US)

(21) Appl. No.: 17/419,020

(22) PCT Filed: Jul. 25, 2019
(86) PCT No.: PCT/US2019/043347

§ 371 Date: Jun. 28, 2021

(51) Int. Cl. G06F 3/023; G06F 11/30; G06F 9/4401

(52) U.S. Cl. CPC G06F 3/0233; G06F 9/4418; G06F 11/3051

(57) ABSTRACT

Example implementations relate to key strike capture. An example non-transitory machine-readable medium can include instructions executable by a processor to capture a key strike when the key strike matches a key strike from predefined hotkey list of key strikes, signal a basic input/output system (BIOS) to wake the processor and signal the BIOS to perform a function associated with the captured key strike during the wake process and responsive to a query from the BIOS.

### BACKGROUND

Sleep state is a low power mode for computing devices that can be used to reduce electrical consumption by the computing device as compared to leaving the computing device fully on. Entering a sleep state may be equivalent to “pausing” the state of the computing device such that when the computing device wakes (e.g., is restored), an operation continues from a previously saved execution state, having same applications and files open as when the computing device entered the sleep state. A sleep state may include a sleep mode (e.g., S5), a hibernation state, or a hybrid sleep state among others. In some examples, a computing device may be placed in an off state, such that the computing device is powered off.

### BRIEF DESCRIPTION OF THE DRAWINGS

FIG. 1 illustrates a system for key strike capture including a controller, a graphical user interface (GUI), and computing devices housing controllers and basic input/output systems (BIOS) according to an example;

FIG. 2 illustrates another system for key strike capture including a processor and a non-transitory machine-readable medium (MRM);

FIG. 3 illustrates a diagram of a controller including a processor, a memory resource; and engines according to an example; and

FIG. 4 illustrates a method for key strike capture according to an example.

### DETAILED DESCRIPTION

Computing devices may be placed in a sleep state or an off state to preserve electrical energy consumption. When a user wants to wake the computing device, the user can strike keys on a keyboard communicatively coupled to the computing device, move a mouse coupled to the computing device, or press a power button of the computing device, among other wake processes. As used herein, a computing device can be a mechanical or electrical device that transmits or modifies energy to perform or assist in the performance of human tasks. Examples include thin clients, personal computers, printing devices, laptops, tablets, smartphones, mobile devices, and gaming consoles, among others. As used herein, “communicatively coupled” can include coupled via various wired and/or wireless connections between devices such that data can be transferred in various directions between the devices. The coupling need not be a direct connection, and in some examples, can be an indirect connection.

Unintentional waking of the computing device can occur when a user accidentally moves the computing device (bumps the computing device, bumps a desk hold the computing device, etc.), or strikes a key (e.g., drops something on the keyboard, cleans the keyboard, etc.) among other unintentional wake actions. In some examples, an unwanted user may try to access the device and may strike a key or perform another wake action to wake and access the computing device.

Some approaches to preventing undesired waking (e.g., unintentional, unapproved, etc.) include allowing the computing device to wake after a particular key is struck. For instance, a specialized keyboard may be used such that when a particular key on the specialized keyboard is struck does the associated computing device wake. Other approaches utilize an intentional delay during a pre-operating system boot time to allow for a user to strike a particular key to wake the computing device or launch an application, which can result in slow boot times and/or missed hotkey strike opportunities (e.g., missed the window of intentional delay).

In contrast, examples of the present disclosure include a controller (e.g., a microcontroller) that is embedded in a computing device such that it handles system tasks that the computing device's operating system does not. For instance, the controller can receive and process signals from a keyboard coupled to the computing device. The controller can monitor key strikes on the keyboard, which may or may not be a specialized keyboard, and can signal a BIOS to wake the computing device (e.g., via submission of a power management event) and/or perform a particular function or functions. For instance, a user striking a particular key may result in waking of a computing device and launching a setup and configuration application. In some examples, the user may strike a particular key combination (e.g., Ctrl+Alt+F10 simultaneously) or key sequence (e.g., F10 then F5, then F7, then enter).

Examples of the present disclosure can reduce delay or possible failure from a user's point of view because a BIOS doesn't continuously watch for particular key strikes, rather it is focused on other tasks (e.g., setup, component configuration, etc.). A user may strike a particular key with no success. In contrast, the controller of the present disclosure can be located, for instance, on a motherboard of a computing device such as a thin client and can monitor the keyboard for particular key strikes and signal the BIOS when the particular key strike or strikes occur. The BIOS can then wake an associated processor (thus waking the computing device) and perform a function associated with the particular key strike or strikes.

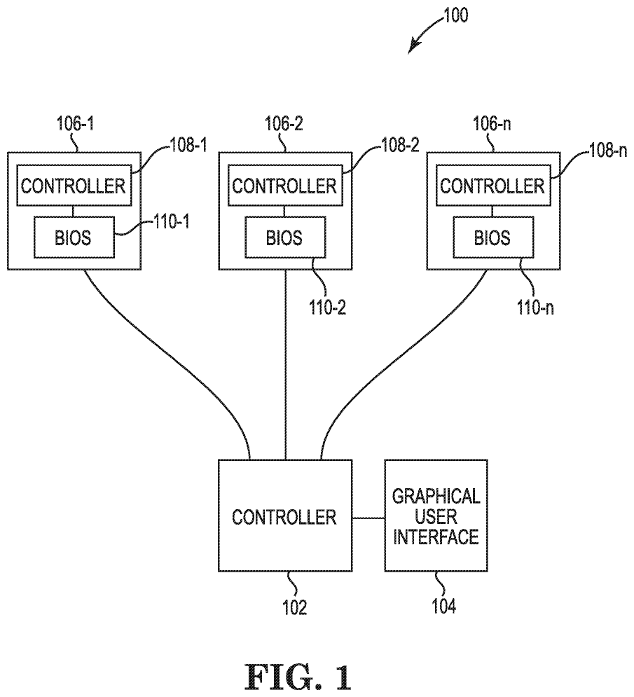

FIG. 1 illustrates a system 100 for key strike capture including a controller 102, a graphical user interface (GUI) 104, and computing devices 106-1, 106-2, . . . , 106-n (referred to herein after collectively as computing devices 106) housing controllers 108-1, 108-2, . . . , 108-n (referred to herein after collectively as controllers 108), and basic input/output systems (BIOS) 110-1, 110-2, . . . , 110-n (referred to herein after collectively as BIOS 110), according to an example. For example, the controllers 108 and BIOS 110 can be housed (e.g., deployed) on a different one of a plurality of associated computing devices 106. The controllers 108, in some examples, are microcontrollers, such that they are small computers on single integrated circuits. The controllers 108 may be embedded microcontrollers, such that they are compact integrated circuits designed to govern a specific operation in their respective computing device 106. A microcontroller may include a processor, memory and input/output (I/O) peripherals on a single chip, in some examples.

The controller 102 can be communicatively coupled to the GUI 104, computing devices 106, BIOS 110, and/or controllers 108. The controller 102 can be responsible for deploying tasks (e.g., requests for particular key strikes to be associated with particular functions) to individual computing devices 106 for execution and gathering of responses to those tasks.

The controller 108 can monitor an associated keyboard of a computing device 106 for a particular key strike when the computing device 106 is in a sleep or off state. For instance, a controller 108-1 can monitor key strikes of keyboards communicatively coupled to computing device 106-1 and coordinate that signal with a platform of the computing device 106-1 to wake the processor of the computing device 106-1 (and as a result the computing device 106-1). The key strike may wake the computing device 106-1 and also launch other functions; for instance, an F10 key strike may wake computing device 106-1 and launch a particular application such as a boot menu. The key strike may alternatively launch a particular boot function such as booting into a network resource, system configurations, operating system resources detected on a storage medium, or a diagnostic environment, among others.

In some examples, the particular key strikes may be part of a predefined hotkey list of key strikes. The predefined hotkey list of key strikes can include key strikes (e.g., including single key strikes, key strike combinations, and/or key strike sequences) and their associated functions. For instance, the list may include F10 and its associated function of waking an associated computing device and launching the computing device in safe mode. The predefined hotkey list of key strikes can be preconfigured on the controller 108 (e.g., at the factory) or can be user-defined (e.g., end user, administrator, etc.). For instance, if the computing device 106-1 is a thin client, an administrator may send instructions via the GUI 104 and the controller 102 to the controller 108-1 to watch for particular key strikes. Alternatively or additionally, an end user may be allowed to configure the predefined hotkey list of key strikes (e.g., via a BIOS interface, operating configuration, etc.). For example, the predefined hotkey list can be a user-defined predefined hotkey list.

In an example in which the controller 102 receives a request to associate a particular key strike with a particular function of a computing device 106 (e.g., launching a particular application), a user may choose a particular key strike sequence to wake a computing device 106-1. The request, for instance, may come via a GUI of the computing device 106-1. The controller 102 can deploy instructions to the controller 108-1 to associate the particular key strike with the particular function. An example may be when the computing device 106-1 is locked in a cage, making a power button difficult to reach. In such an example, a user may choose a particular key strike sequence or key strike combination that acts similar to a password in that it allows a user to wake the computing device 106-1 and perform a desired function without others knowing the key strike combination or sequence.

In some example, the controllers 108 may function to monitor and capture key strikes, allowing the controllers to focus on monitoring the keyboards of the computing devices 106 rather than other functions of the computing devices 106. When a controller, such as controller 108-2, captures a key strike when the key strike matches a key strike from a predefined hotkey list of key strikes, the controller 108-2 signals the BIOS 110-2 to wake the processor from a sleep or off state and perform a particular function associated with the key strike. In some examples, the controller 108-2 receives a query from the BIOS 110-2 early in the BIOS's 110-2 processing and makes determinations about what boot path and devices to query instead of performing a general query of all devices. For instance, if the desired function is a boot function, the boot function can be performed during the wake process of the BIOS 110-2. In some example, such a configuration can be temporary (e.g., just for this particular boot) and may not change a predefined path of the BIOS 110-2 (e.g., a path predefined by a user selection or preconfigured).

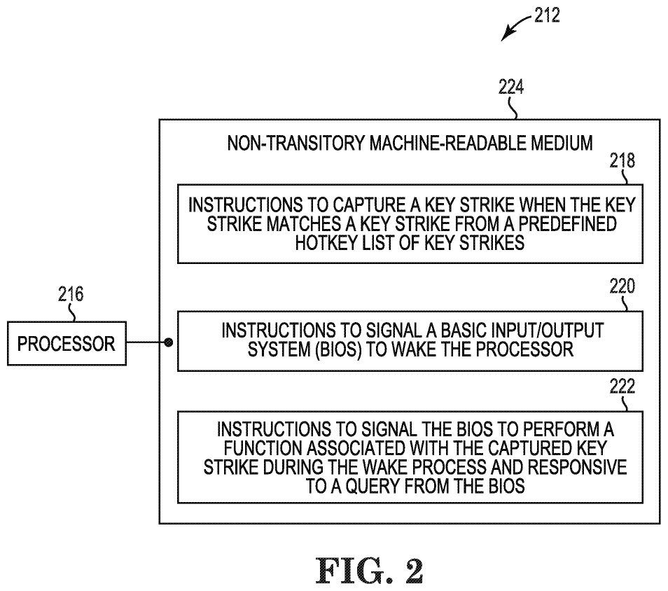

FIG. 2 illustrates another system 212 for key strike capture including a processor 216 and a non-transitory machine-readable medium (MRM) 224. The system 212 can be a controller, microcontroller, or a computing device (among others) in some examples and can include the processor 216. System 212 can further include the non-transitory MRM 224, on which may be stored instructions, such as instructions 218, 220, and 222. Although the following descriptions refer to a processor and a memory resource, the descriptions may also apply to a system with multiple processors and multiple memory resources. In such examples, the instructions may be distributed (e.g., stored) across multiple non-transitory MRMs and the instructions may be distributed (e.g., executed by) across multiple processors.

The non-transitory MRM 224 may be electronic, magnetic, optical, or other physical storage device that stores executable instructions. Thus, non-transitory MRM 224 may be, for example, Random Access Memory (RAM), an Electrically-Erasable Programmable ROM (EEPROM), a storage drive, an optical disc, and the like. The non-transitory MRM 224 may be disposed within a controller and/or computing device. In this example, the executable instructions 218, 220, and 222 can be “installed” on the device. Additionally and/or alternatively, the non-transitory MRM 224 can be a portable, external or remote storage medium, for example, that allows the system 212 to download the instructions 218, 220, and 222 from the portable/external/remote storage medium. In this situation, the executable instructions may be part of an “installation package”. As described herein, the non-transitory MRM 224 can be encoded with executable instructions for key strike capture.

The non-transitory MRM 224 can, in some examples be loaded to a controller from a registry. Loaded, in some examples, can include the non-transitory MRM 224 and the instructions 218, 220, and/or 222 being saved to the controller from the registry. The registry, for instance, can include an online catalog. In some instances, the non-transitory MRM 224 can be secured with a signature. This can create assurance that the non-transitory MRM 224 came from a trusted source and is a source of tamper protection. Signatures, for instance, can be considered for instructions 218, 220, and/or 222 in some examples, along with the entire non-transitory MRM 224.

The instructions 218, when executed by a processor such as the processor 216, can include instructions to capture a key strike when the key strike matches a key strike from a predefined hotkey list of key strikes. For instance, key strikes on a keyboard associated with a computing device can be monitored for particular key strikes matching a key strike from the predefined hotkey list of key strikes. Responsive to a match, the key strike is captured, and a signal is sent to an associate BIOS. For instance, the instructions 220, when executed by a processor such as the processor 216, can include instructions to signal the BIOS to wake the processor 216. For instance, the BIOS may be sent signals to wake the processor 216 from an S5 state or an off state, among other states. In such an example, the processor 216 communicates with the BIOS via a wire interconnect (e.g., I²C, system management bus, etc.). However, examples are not so limited. The processor 216 may communication with the BIOS via a wireless connection.

In some examples, the instructions 222, when executed by a processor such as the processor 216, can include instructions to signal the BIOS to perform a function, such as a boot function, associated with the captured key strike. For instance, a key strike may be captured that indicates waking a computing device and signaling the BIOS to boot in a different mode than its current mode. For instance, the system 212 (e.g., an embedded microcontroller) preserves a predefined hotkey list and captures key strikes (e.g., a single key strike, a key strike combination, or a key strike sequence). When a key strike matches a key strike from the predefined hotkey list, the key strike is captured, and the system 212 executes instructions to signal the BIOS to boot in a different mode.

In some instances, signaling the BIOS can occur during the wake process. For instance, as the processor 216 wakes, the BIOS is signaled to perform an action during the boot process while the BIOS is still making determinations about what boot path and devices to query. In some examples, once the processor 216 is awake (e.g., it has left the sleep or off state), the system 212 ceases monitoring the keyboard.

In some examples, a key strike is not a match to a key strike of the predefined hotkey list of key strikes. In such an example, the instructions may be executable to prevent the BIOS from waking the processor 216. For instance, if someone cleaning a keyboard strikes a plurality of keys, but none (whether single, combination, or sequence) matches a key strike in the predefined hotkey list, no signal is sent to the BIOS, thus preventing unwanted waking of the processor 216.

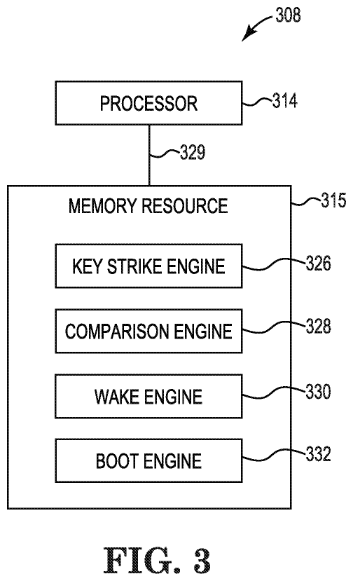

FIG. 3 illustrates a diagram of a controller 308 including a processor 314, a memory resource 315, and engines 326, 328, and 330 according to an example. In some examples, the controller 308 can be an embedded microcontroller and/or a combination of hardware and instructions for key strike capture. The hardware, for example can include the processor 314 and/or the memory resource 315 (e.g., MRM, computer-readable medium (CRM), data store, etc.).

The processor 314, as used herein, can include a number of processing resources capable of executing instructions stored by the memory resource 315. The instructions (e.g., machine-readable instructions (MRI)) can include instructions stored on the memory resource 315 and executable by the processor 314 to implement a desired function (e.g., key strike capture). The memory resource 315, as used herein, can include a number of memory components capable of storing non-transitory instructions that can be executed by the processor 314. The memory resource 315 can be integrated in a single device or distributed across multiple devices. Further, the memory resource 315 can be fully or partially integrated in the same device as the processor 314 or it can be separate but accessible to that device and processor 314. Thus, it is noted that the controller 308 can be implemented on an electronic device and/or a collection of electronic devices, among other possibilities.

The memory resource 315 can be in communication with the processor 314 via a communication link (e.g., path) 329. The communication link 329 can be local or remote to an electronic device associated with the processor 314, The memory resource 315 includes engines (e.g., key strike engine 326, comparison engine 328, wake engine 330, boot engine 332). The memory resource 315 can include more or fewer engines than illustrated to perform the various functions described herein.

The engines 326, 328, 330, and 332 can include a combination of hardware and instructions to perform a number of functions described herein (e.g., key strike capture). The instructions (e.g., software, firmware, etc.) can be downloaded and stored in a memory resource (e.g., MRM) as well as a hard-wired program (e.g., logic), among other possibilities. In some examples, the engines 326, 328, 330, and 332 may be composed on separate computing systems.

The key strike engine 326 can monitor a key strike from a keyboard communicatively coupled to the controller 308. For instance, the controller 308 can monitor single key strikes, key strike combinations, and key strike sequences. A single key strike includes one key struck, a key strike combination includes multiple keys struck simultaneously, and a key strike sequence includes multiple keys struck in a particular order (e.g., with an ending “trigger key” such as the Enter key).

For instance, if the key strike is key strike sequence, the controller 308 monitors a plurality of key strikes from the keyboard and maintains a state of the key strike sequence. Similar, if the key strike is a key strike combination, the controller 308 monitors a plurality of key strikes from the keyboard and maintains a state of the key strike combination. For example, the controller 308 can decide when and if a key strike sequence or combination is occurring and how quickly the keys are input to define them as a key strike sequence (rather than random key entries), a key strike combination, a single key strike, or nothing. The controller 308 can determine if the key strike sequence or key strike combination is correct and if/when an incomplete or incorrect key strike sequence or key strike combination should be invalidated and reset back to an initial state. Once all the conditions are met that make up the key strike sequence or key strike combination, the controller 308 can signal the BIOS.

The comparison engine 328 can compare the key strike to a predefined hotkey list of key strikes. The predefined hotkey list can be preserved on the controller 308, and upon a match of the key strike to a key strike of the predefined hotkey list during the comparison, the controller 308 can capture the key strike and signal the associated BIOS. For instance, the wake engine 330 can signal the BIOS to wake the processor 314 from a sleep state responsive to the monitored key strike matching a key strike from the predefined hotkey list of key strikes. The boot engine 332 can signal the BIOS to perform, during the wake process, a boot function associated with the matched key strike from the predefined hotkey list. The signal can be made during the wake process and responsive to a query from the BIOS, for example.

For instance, the controller 308 may monitor a key strike Ctrl+Shift+F6 simultaneously. The controller 308 compares this key strike (which is a key strike combination) to key strokes in its preserved predefined hotkey list. When a key stroke match occurs, the controller 308 captures the key strike and signals the BIOS to wake the processor 314 and signals the BIOS to boot to a different mode (e.g., a configuration mode associated with the captured key strike).

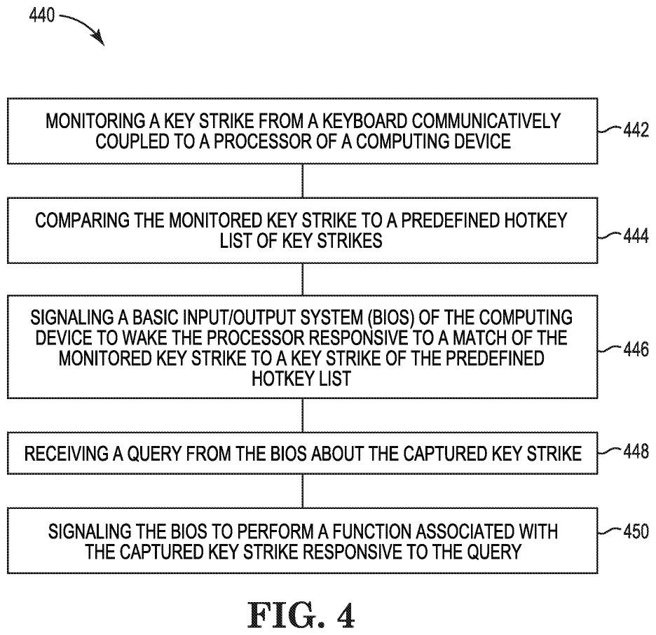

FIG. 4 illustrates a method 440 for key strike capture according to an example. The method 440 may be performed by a system 212 and/or controllers 108, 308 as described with respect to FIGS. 1-3. At 442, the method 440 capturing a key strike from a keyboard communicatively coupled to a processor of a computing device, and at 444, the method 440 includes comparing the monitored key strike to key strikes of a predefined hotkey list of key strikes. In some examples, the keyboard is near-continuously monitored for key strikes on the predefined hotkey list. As used herein, near-continuously includes monitoring without meaningful breaks. For instance, a keyboard can be near-continuously monitored for particular key strikes until the computing device associated with the keyboard wakes or until an outside source stops the monitoring (e.g., an administrator ceases the monitoring, a power outage, etc.).

In some examples, the predefined hotkey list of key strikes and functions associated therewith are stored to a memory device communicatively coupled to the processer, for instance the memory resource 315 coupled to the processor 314 illustrated in FIG. 3, The predefined hotkey list is preserved so that a controller knows which key strikes to look for during monitoring.

The method 440, at 446 includes signaling a BIOS of the computing device to capture the monitored key strike and wake the processor responsive to a match of the monitored key strike to a key strike of the predefined hotkey list, and at 448, the method 440 includes receiving a query from the BIOS about the captured key strike. For instance, a BIOS may be signaled to wake, and the BIOS can then query the controller that captured the key strike what the BIOS should do. The method 440, at 450 includes signaling the BIOS to perform a function associated with the captured key strike responsive to the query. For example, the controller can reference the predefined hotkey list and signal to the BIOS which function to perform. For instance, different key strikes can be used to launch different boot modes such as boot to BIOS setup, boot menu, diagnostics, default operating system loader, network boot, and recovery partition, among others.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. Elements shown in the various figures herein may be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense. Further, as used herein, “a number of” an element and/or feature may refer to one or more of such elements and/or features.

What is claimed is:

1. A non-transitory machine-readable medium storing instructions executable by a processor to cause the processor to:
capture a key strike when the key strike matches a key strike from a predefined hotkey list of key strikes; signal a basic input/output system (BIOS) to wake the processor; and
during the wake process and responsive to a query from the BIOS, signal the BIOS to perform a function associated with the captured key strike.

2. The medium of claim 1, wherein the key strike is a key strike combination.

3. The medium of claim 1, wherein the key strike is a key strike sequence.

4. The medium of claim 1, wherein the processor communicates with the BIOS via a wire interconnect.

5. The medium of claim 1, further comprising the instructions executable to:
observe a key strike that is not a match to a key strike from the predefined hotkey list of key strikes; and
prevent the BIOS from waking the processor.

6. The medium of claim 1, further comprising the instructions executable to signal the BIOS to wake the processor from an S5 state.

7. The medium of claim 1, further comprising the instructions executable to signal the BIOS to wake the processor from an off state.

8. The medium of claim 1, wherein the instructions executable to signal the BIOS to perform the function comprise instructions executable to signal the BIOS to perform a boot function during the wake process.

9. A controller comprising a processor in communication with a memory resource including instructions executable to:
monitor a key strike from a keyboard communicatively coupled to the controller;
compare the key strike to a predefined hotkey list of key strikes;
responsive to the monitored key strike matching a key strike from the predefined hotkey list of key strikes, capture the monitored key strike and signal a basic input/output system (BIOS) of the computing device to wake the processor from a sleep state; and
during the wake process and responsive to a query from the BIOS, signal the BIOS to perform, during the wake process, a boot function associated with the matched key strike from the predefined hotkey list.

10. The controller of claim 9, wherein:
the captured key strike is a key strike sequence; and
the instructions are executable to:
monitor a plurality of key strikes from the keyboard; and
maintain a state of the key strike sequence.

11. The controller of claim 9, wherein:
the captured key strike is a key strike combination; and
the instructions are executable to:
monitor a plurality of key strikes from the keyboard; and
maintain a state of the key strike combination.

12. The controller of claim 9, wherein the predefined hotkey list is a user-defined predefined hotkey list.

13. A method, comprising:
monitoring a key strike from a keyboard communicatively coupled to a processor of a computing device;
comparing the monitored key strike to a predefined hotkey list of key strikes;
signaling a basic input/output system (BIOS) of the computing device to wake the processor responsive to a match of the monitored key strike to a key strike of the predefined hotkey list;
receiving a query from the BIOS about the captured key strike; and
responsive to the query, signaling the BIOS to perform a function associated with the captured key strike.

14. The method of claim 13, further comprising near-continuously monitoring the keyboard for key strikes on the predefined hotkey list.

15. The method of claim 13, further comprising preserving the predefined hotkey list of key strikes and associated functions to a memory device communicatively coupled to the processor.
